(19) United States
(12) Patent Application Publication
(10) Pub. No.: US 2026/0216601 A1
(43) Pub. Date: Jul. 30, 2026

(54) VIRTUAL CHARACTER CONTROL METHOD AND APPARATUS, AND ELECTRONIC DEVICE

(71) Applicant: NETEASE (HANGZHOU) NETWORK CO., LTD., Hangzhou, Zhejiang (CN)

(72) Inventor: Weinan LI, Foshan, Guangdong (CN)

(73) Assignee: NETEASE (HANGZHOU) NETWORK CO., LTD., Hangzhou, Zhejiang (CN)

(21) Appl. No.: 19/143,478

(22) PCT Filed: May 23, 2023
(86) PCT No.: PCT/CN2023/095884

§ 371 Date: Jun. 26, 2025

(30) Foreign Application Priority Data
Dec. 26, 2022 (CN) 202211675284.5

(51) Int. Cl. A63F 13/56; A63F 13/533; A63F 13/795

(52) U.S. Cl. CPC A63F 13/56; A63F 13/533; A63F 13/795

(57) ABSTRACT

A method for controlling a virtual character includes: in response to a following evacuation event triggered by a first virtual character at a target evacuation point, determining, according to a pre-specified team evacuation rule, a target virtual character that is evacuated along with the first virtual character, the first virtual character is controlled by the first terminal device, and the first virtual character and the target virtual character belong to a same game camp; and, controlling to evacuate the first virtual character and the target virtual character from the game battle together.

### CROSS REFERENCE TO RELATED APPLICATIONS

The present application is a National Stage Application of International Application No. PCT/CN2023/095884 filed on May 23, 2023 which is based upon and claims the priority of Chinese Patent Application No. 202211675284.5 entitled “Method for controlling a virtual character, Apparatus, and Electronic Device,” filed on Dec. 26, 2022, the entire contents of both of which are incorporated here by reference in their entirety for all purposes.

### TECHNICAL FIELD

The present disclosure relates to the field of game technology, and in particular, to a method for controlling a virtual character, an apparatus, and an electronic device.

### BACKGROUND

In some team-forming games, after a virtual character enters a game battle, the virtual character is usually required to, after completing a target task, move to a specified scene position to complete a specified game event, so that the virtual character may leave the game scene successfully, and the virtual character may win the game battle.

### SUMMARY

According to an aspect of the present disclosure, there is provided a method for controlling a virtual character performed by a first terminal device, where a graphical user interface is provided by the first terminal device, a content displayed on the graphical user interface includes at least a part of a game battle scene, the game battle scene includes at least one evacuation point, the at least one evacuation point is configured to provide a service of evacuation from a game battle for a virtual character that satisfies an evacuation condition, and the method includes: in response to a following evacuation event triggered by a first virtual character at a target evacuation point, determining, according to a pre-specified team evacuation rule, a target virtual character that is evacuated along with the first virtual character, where the first virtual character is controlled by the first terminal device, and the first virtual character and the target virtual character belong to a same game camp; and controlling to evacuate the first virtual character and the target virtual character from the game battle together.

According to an aspect of the present disclosure, there is further provided a method for controlling a virtual character performed by a second terminal device, where a graphical user interface is provided by the second terminal device, a content displayed on the graphical user interface includes at least a part of a game battle scene, the game battle scene includes at least one evacuation point, the at least one evacuation point is configured to provide a service of evacuation from a game battle for a virtual character that satisfies an evacuation condition, and the method includes: in response to a following evacuation event triggered by a first virtual character at a target evacuation point, determining whether a second virtual character satisfies a specified following evacuation condition, where the first virtual character is controlled by a first terminal device, the second virtual character is controlled by the second terminal device, the first virtual character and the second virtual character belong to a same game camp, and the following evacuation condition is configured to indicate whether the second virtual character is allowed to follow the first virtual character for evacuation from the game battle; and, in response to the second virtual character satisfying the specified following evacuation condition, controlling to evacuate the second virtual character and the first virtual character from the game battle together.

According to an aspect of the present disclosure, there is further provided an electronic device, including a processor and a memory, where the memory stores a computer-executable instruction executable by the processor, and the processor executes the computer-executable instruction to implement the method for controlling the virtual character according to any one of the first aspect, or implement the method for controlling the virtual character according to any one of the second aspect.

According to an aspect of the present disclosure, there is further provided a computer-readable storage medium, where a computer-executable instruction is stored on the computer-readable storage medium, and when the computer-executable instruction is invoked and executed by the processor, the computer-executable instruction causes the processor to implement the method for controlling the virtual character according to any one of the first aspect or implement the method for controlling the virtual character according to any one of the second aspect.

### BRIEF DESCRIPTION OF THE DRAWINGS

FIG. 1 is a flowchart of a method for controlling a virtual character provided according to some embodiments of the present disclosure;

FIG. 2 is a schematic diagram of a graphical user interface provided according to some embodiments of the present disclosure;

FIG. 3 is a schematic diagram of another graphical user interface provided according to some embodiments of the present disclosure;

FIG. 4 is a schematic diagram of another graphical user interface provided according to some embodiments of the present disclosure;

FIG. 5 is a schematic diagram of another graphical user interface provided according to some embodiments of the present disclosure;

FIG. 6 is a schematic diagram of another graphical user interface provided according to some embodiments of the present disclosure;

FIG. 7 is a flowchart of another method for controlling a virtual character provided according to some embodiments of the present disclosure;

FIG. 8 is a schematic structural diagram of an apparatus for controlling a virtual character provided according to some embodiments of the present disclosure;

FIG. 9 is a schematic structural diagram of another apparatus for controlling a virtual character provided according to some embodiments of the present disclosure;

FIG. 10 is a schematic structural diagram of an electronic device provided according to some embodiments of the present disclosure.

### DETAILED DESCRIPTION

In order to make the objectives, technical solutions, and advantages of the embodiments of the present disclosure clearer, the technical solutions of the present disclosure will be clearly and completely described below with reference to the accompanying drawings. Obviously, the described embodiments are a part of the embodiments of the present disclosure, not all the embodiments of the present disclosure. All other embodiments obtained by those skilled in the art based on the embodiments of the present disclosure without creative efforts shall fall within the protection scope of the present disclosure.

Currently, in some team-forming games, after a virtual character enters a game battle, the virtual character is usually required to, after completing a target task, move to a specified scene position to complete a specified game event, so that the virtual character may leave the game scene successfully, and the virtual character may win the game battle. In the related art, the manner of winning by the virtual character is not related to whether a teammate of the virtual character successfully leaves the game scene, and, for team-forming players who play the game by forming a team, this is no direct benefit relationship between the game results of the teammate players, resulting in that the willingness of the player to form a team is reduced, and the player loses the game experience of forming a team, which leads to a poor game experience of the player. Based on this, according to the embodiments of the present disclosure, there is provided a method for controlling a virtual character, an apparatus and an electronic device. By presetting a specified teammate evacuation rule, a part of virtual characters belonging to a same game camp can be controlled to be evacuated from a game battle together by following each other, so as to improve the team-forming willingness of the player in the game, thus improving the game experience of the player. The technology may be applied to devices such as a mobile phone, a computer, a notebook, a tablet computer, or the like.

The method for controlling the virtual character according to some embodiments of the present disclosure may run on a local terminal device or a server. When the method for controlling the virtual character runs on the server, the method may be implemented and executed based on a cloud interaction system, where the cloud interaction system includes a server and a client device.

In some embodiments, various cloud applications may be run in the cloud interaction system, such as cloud games. Taking a cloud game as an example, a cloud game refers to a game mode based on cloud computing. In the running mode of the cloud game, the running body of the game program and the presentation body of the game screen are separated, and the storage and operation of the method for controlling the virtual character are completed on the cloud game server. The function of the client device is used for data receiving, data sending and game screen presentation. For example, the client device may be a display device with a data transmission function close to the user side, such as a mobile terminal, a television, a computer, a palmtop computer, or the like. However, it is the cloud game server on the cloud that performs information processing. During the game, the player operates the client device to send an operation instruction to the cloud game server; the cloud game server runs the game according to the operation instruction, encodes and compresses the data such as the game screen, and returns the data to the client device through a network; and finally, the client device decodes the data and outputs the game screen.

In some embodiments, taking a game as an example, the local terminal device stores a game program and is configured to present a game screen. The local terminal device is configured to interact with the player through a graphical user interface, i.e., conventionally to download and install a game program by using an electronic device and run it. The manner in which the local terminal device provides the graphical user interface to the player may include a plurality of manners. For example, the graphical user interface may be rendered and displayed on a display screen of the terminal, or the graphical user interface may be provided to the player by holographic projection. For example, the local terminal device may include a display screen and a processor, the display screen is configured to present the graphical user interface, the graphical user interface includes a game screen, and the processor is configured to run the game, generate the graphical user interface, and control display of the graphical user interface on the display screen.

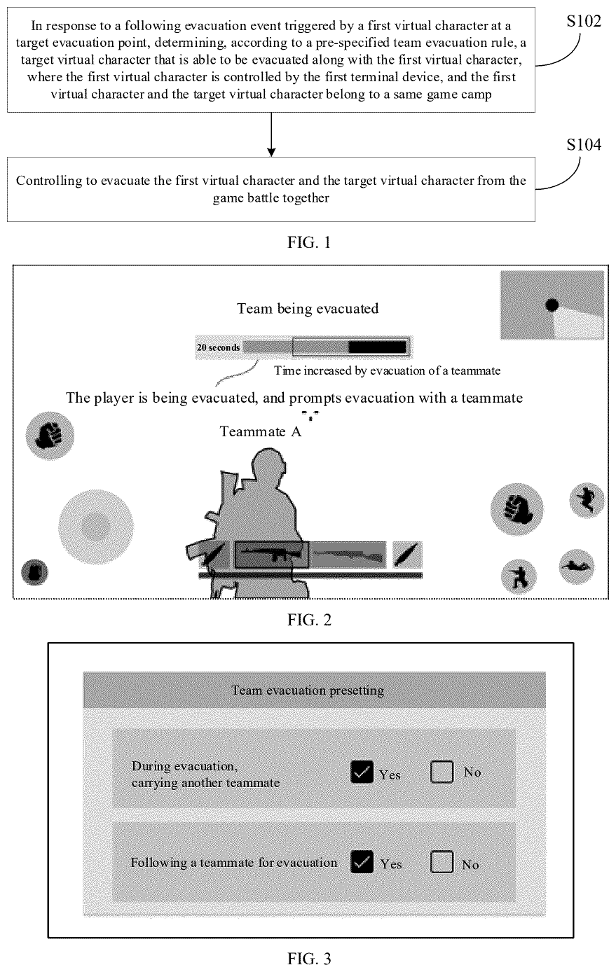

According to some embodiments of the present disclosure, there is provided a method for controlling a virtual character. A graphical user interface is provided by a first terminal device, where the first terminal device may be the foregoing local terminal device, or may be a client device in the foregoing cloud interaction system. Among them, the content displayed on the graphical user interface includes at least a part of a game battle scene, the game battle scene includes at least one evacuation point, and the at least one evacuation point is configured to provide a service of evacuation from the game battle for the virtual character that satisfies an evacuation condition. As shown in FIG. 1, the method includes the following steps.

In step S102, in response to a following evacuation event triggered by a first virtual character at a target evacuation point, a target virtual character that is able to be evacuated along with the first virtual character is determined according to a pre-specified team evacuation rule, where the first virtual character is controlled by the first terminal device, and the first virtual character and the target virtual character belong to the same game camp.

The graphical user interface may display a game battle screen of a game battle scene, which specifically includes a screen formed by collecting the game battle scene using a virtual camera corresponding to the first virtual character, where the game battle scene includes the first virtual character and a teammate virtual character that belongs to the same camp as the first virtual character. The first virtual character may be an escape party or a tracked party in the game battle, and the first virtual character in the actual game battle usually has a plurality of teammate virtual characters, for example, two or three teammate virtual characters. The player may click on the game start control in the game start interface to control the first virtual character to enter the game battle scene; and meanwhile, the graphical user interface may display the game battle screen of the game battle scene. The game battle screen may be a screen from a first person perspective of the first virtual character, or a screen from a third person perspective of the first virtual character. Generally, the game battle further includes at least one enemy virtual character, which belongs to a different game camp from the first virtual character. The target virtual character is usually controlled by a second terminal device.

The target evacuation point is usually a preset scene position, and the target evacuation point may be an evacuation position of the virtual character. After the virtual character in the game battle scene moves to the target evacuation point, a target game behavior may be performed to enable the first virtual character to satisfy the evacuation condition corresponding to the target evacuation point, and trigger the following evacuation event; or, the target game behavior may not be performed, and after detecting that the first virtual character moves to the target evacuation point, the game system may automatically trigger the following evacuation event. Among them, the target game behavior may be clicking on a control, or controlling the first virtual character to perform a jump action, a get-on action, repair of a password lock, or the like. The following evacuation event generally refers to an evacuation behavior of the first virtual character, and may be understood as an event that the first virtual character leaves the game battle scene.

When the following evacuation event is triggered, a target virtual character that is able to be evacuated along with the first virtual character needs to be determined according to a pre-specified team evacuation rule, where the team evacuation rule at least includes a preset evacuation rule for the first virtual character and a preset evacuation rule for a teammate virtual character belonging to the same game camp as the first virtual character. The evacuation rule includes whether being willing to carry the teammate virtual character for evacuation together, and whether being willing to follow the teammate virtual character for evacuation together. Therefore, according to the pre-specified team evacuation rule, the preset evacuation rule for the first virtual character and the preset evacuation rule for the teammate virtual character belonging to the same game camp as the first virtual character may be determined. According to the evacuation rule, it is determined whether the first virtual character is willing to carry the teammate virtual character for evacuation, and whether the teammate virtual character is willing to follow the first virtual character for evacuation together. If the first virtual character is willing to carry the teammate virtual character for evacuation, and the target teammate virtual character in the teammate virtual character is willing to follow the first virtual character for evacuation together, it may be determined that the target teammate virtual character is the target virtual character that is able to be evacuated along with the first virtual character.

The specified team evacuation rule is usually set before the game battle starts. For example, it is set as that when the first virtual character is evacuated from the game battle, the teammate virtual character is allowed to follow, that is, the teammate virtual character is allowed to follow the first virtual character for evacuation from the game battle together. For another example, during actual implementation of the setting that the teammate virtual character follows the first virtual character for evacuation from the game battle together when the teammate virtual character is evacuated from the game battle, it may be pre-set by using a control selection manner.

In step S104, the first virtual character and the target virtual character are controlled to be evacuated from the game battle together.

It may be understood that, if the first virtual character is preset with an evacuation rule of being willing to carry the teammate virtual character for evacuation together, after the first virtual character triggers the following evacuation event, the target virtual character that is able to be evacuated along with the first virtual character is determined, and the first virtual character and the target virtual character may be controlled to be evacuated from the game battle together. That is, whether the target virtual character is at the target evacuation point or not, in the same way as the first virtual character, the behavior of evacuation from the game battle may also be performed on the target virtual character.

According to some embodiments of the present disclosure, there is provided a method for controlling a virtual character. In response to a following evacuation event triggered by a first virtual character at a target evacuation point, a target virtual character that is able to be evacuated along with the first virtual character is determined according to a pre-specified team evacuation rule; the first virtual character and the target virtual character belong to the same game camp; and, the first virtual character and the target virtual character are controlled to be evacuated from the game battle together. In this way, by using the pre-specified team evacuation rule, the evacuation rule for the first virtual character and the evacuation rule for the virtual character that belongs to the same camp as the first virtual character may be determined, so as to determine the target virtual character that is able to be evacuated along with the first virtual character, and control to evacuate the first virtual character and the target virtual character from the game battle together, thus improving the team-forming willingness of the player in the game, and further improving the game experience of the player.

In In step S104, for the step of controlling to evacuate the first virtual character and the target virtual character from the game battle together, a possible implementation is as follows.

In response to a quantity of the target virtual character being 0, the first virtual character is controlled to be evacuated from the game battle within a first preset time.

The first preset time may be preset according to a game requirement, for example, 30 seconds or 40 seconds. In some embodiments, the first preset time may be positively correlated with the quantity of the virtual item carried by the first virtual character. For example, if the first virtual character does not carry any virtual item, the first preset time is 30 seconds; and if the first virtual character carries a first quantity (for example, one) of virtual items, the first preset time is 35 seconds. During actual implementation, the first virtual character is controlled to be located at the target evacuation point; and after the first preset time is waited, the first virtual character is controlled to leave the game battle scene.

In another possible implementation,
in response to the quantity of the target virtual character being not 0, the first virtual character and the target virtual character are controlled to be evacuated from the game battle within a second preset time, where the second preset time is greater than the first preset time, and the second preset time is positively correlated with the quantity of the target virtual character. Among them, the second preset time is further positively correlated with a quantity of the virtual item obtained by the first virtual character and the target virtual character in the game battle.

The second preset time may be preset according to a game requirement, for example, 40 seconds, 50 seconds, or the like. In some embodiments, the second preset time may be positively correlated with the quantity of the target virtual character and the quantity of the virtual item carried by the target virtual character. For example, if the quantity of the target virtual character is 1, the second preset time is 35 seconds; or, if the quantity of the target virtual character is 2, the second preset time is 40 seconds. For another example, if the quantity of the target virtual character is 1, and the quantity of the virtual item obtained by the target virtual character in the game battle is 0, the second preset time is 35 seconds; or, if the quantity of the target virtual character is 2, and the quantity of the virtual item obtained by the target virtual character in the game battle is 1, the second preset time is 40 seconds. During actual implementation, the first virtual character is controlled to be located at the target evacuation point, the target virtual character is located at the specified position or the current position; and after the second preset time is waited, the first virtual character and the target virtual character are controlled to leave the game battle scene simultaneously.

In this way, considering the balance, when there is a teammate cancelling to be evacuated by following with the player together, or when the virtual item carried by the player and the teammate are reduced, the evacuation time of the player is reduced, and the interestingness and playability of the game are improved.

For the step of controlling to evacuate the first virtual character and the target virtual character from the game battle together, a possible implementation is as follows.

The graphical user interface is controlled to display first prompt information, where the first prompt information at least includes first target time information, and the first target time information is at least configured to prompt a waiting duration required for evacuation of the first virtual character and the target virtual character from the game battle together. In response to reaching the waiting duration, the first virtual character and the target virtual character are controlled to be evacuated from the game battle together.

During actual implementation, the graphical user interface is controlled to display the first prompt information, a first target time, and a countdown of the first target time, where the first prompt information is configured to prompt that the first virtual character is being evacuated from the game battle. The first target time is the first preset time or the second preset time, and is configured to, prompt a waiting duration required for evacuation of the first virtual character from the game battle, or prompt the waiting duration required for evacuation of the first virtual character and the target virtual character from the game battle together.

For example, as shown in FIG. 2, “Team being evacuated” in FIG. 2 corresponds to the first prompt information configured to prompt the player that the current first virtual character is being evacuated from the game battle. “Teammate A” in FIG. 2 corresponds to the first virtual character controlled by the player. “20 seconds” in FIG. 2 corresponds to the first target time. The black bar-shaped frame in FIG. 2 corresponds to the countdown of the first target time. It should be noted that, generally, the waiting duration required for evacuation of the first virtual character from the game battle itself is only 5 seconds; and, every time the target virtual character to be evacuated from the game battle together with the first virtual character is added by 1, the waiting duration needs to be added by 5 seconds on the basis of 5 seconds. 20 seconds shown in FIG. 2 may prompt the player that it is currently being evacuated from the game battle together with the target virtual character (i.e., a teammate virtual character), and it may also be inferred according to the shown 20 seconds that the first virtual character is being evacuated from the game battle together with three target virtual characters, that is, the first virtual character is carrying three teammate virtual characters for evacuation together.

It may be understood that the first target time is correlated with the quantity of the target virtual character and the quantity of the virtual item carried by the first virtual character; or, the first target time is correlated with the quantity of the target virtual character; or, the first target time is correlated with the quantity of the virtual item carried by the first virtual character. In some embodiments, every time the virtual character following the first virtual character for evacuation from the game battle together is added by 1, the first target time and the countdown of the first target time may both be increased by a preset time, for example, 5 seconds or 10 seconds.

In this manner, when there is a teammate that is evacuated together by following the player, prompt information and the time required for evacuation may be displayed on the game interface of the player to remind the player of the current evacuation state.

Furthermore, the step of controlling to evacuate the first virtual character and the target virtual character from the game battle together further includes: in response to the target virtual character being cancelled to follow the first virtual character for evacuation from the game battle together, the evacuation of the target virtual character form the game battle is cancelled; and simultaneously, the first target time and the countdown of the first target time are controlled to be reduced by the first specified time.

In some embodiments, in response to the virtual item obtained by the first virtual character and the target virtual character in the game battle being reduced by the first quantity, the first target time and the countdown of the first target time are controlled to be reduced by the second specified time.

The first specified time may generally be preset according to the actual game requirement, and may be 5 seconds, 10 seconds, or the like. The first quantity generally refers to a virtual item, which may generally be preset according to actual game requirement. The second specified time may be 0.2 seconds or 0.5 seconds. When the first virtual character carries the target virtual character for evacuation from the game battle together, if the following target virtual character cancels the following, the first target time and the countdown of the first target time displayed by the graphical user interface may be updated at this time, that is, the first target time and the countdown of the first target time is reduced. When the first virtual character carries the target virtual character for evacuation from the game battle together, if the carried virtual item is reduced by one, the first target time and the countdown of the first target time displayed by the graphical user interface may also be updated at this time, that is, the first target time and the countdown of the first target time are reduced. For example, if there is originally three target virtual characters following the first virtual character for evacuation from the game battle together, and now it becomes two, the first target time may change from 20 seconds to 15 seconds. For another example, if the first virtual character carries five virtual items originally, and now it is reduced to four virtual items, the first target time may change from 1 second to 0.8 seconds.

For the step of in response to the following evacuation event triggered by the first virtual character at the target evacuation point, determining, according to the pre-specified team evacuation rule, the target virtual character that is able to be evacuated along with the first virtual character, a possible implementation is described as follows.

(1) In response to the following evacuation event triggered by the first virtual character at the target evacuation point, a first evacuation rule pre-specified for the first virtual character and a second evacuation rule pre-specified for the second virtual character are determined, where the second virtual character is a virtual character controlled by the second terminal device.

The first evacuation rule pre-specified for the first virtual character is usually determined in the following manner.

In response to the game battle starting, a preset team evacuation rule is displayed on the graphical user interface, where the team evacuation rule at least includes whether being willing to carry the teammate for evacuation together and whether being willing to follow the teammate for evacuation together; and, in response to a selection operation for a target evacuation rule in the team evacuation rule, it is determined that the target evacuation rule is the first evacuation rule corresponding to the first virtual character.

In some embodiments, in response to the game battle starting, an evacuation control for the first virtual character is displayed on the graphical user interface; and in response to a first trigger operation on the evacuation control for the first virtual character, the first evacuation rule for the first virtual character is determined.

The evacuation control generally includes a first evacuation control and a second evacuation control. If the player clicks on the first evacuation control, the determined team evacuation rule for the first virtual character is the first evacuation rule, that is, being willing to carry the target virtual character as the teammate for evacuation together. If the player clicks on the second evacuation control, the determined team evacuation rule for the first virtual character is the second evacuation rule, that is, being willing to follow the first virtual character as the teammate for evacuation together.

For example, as shown in FIG. 3, “During evacuation, carrying another teammate” is the evacuation control. If the player clicks on “Yes”, the determined team evacuation rule for the first virtual character is the first evacuation rule, that is, being willing to carry the target virtual character as the teammate for evacuation together. If the player clicks on “No”, the determined evacuation rule for the first virtual character is unwilling to carry the target virtual character as the teammate for evacuation together.

Similarly, the second evacuation rule is determined in the following manner. In response to receiving following operation information of a following control for a teammate virtual character, the second evacuation rule for the teammate virtual character is determined, where the teammate virtual character is controlled by the second terminal device. The graphical user interface provided by the second terminal device includes the following control for the teammate virtual character, and the second evacuation rule for the teammate virtual character is configured to indicate that the second terminal device, in response to a second trigger operation on the following control for the teammate virtual character, obtains the following operation information of the following control for the teammate virtual character.

Similarly, the teammate of the player may also set its own evacuation rule on the second terminal device controlled by teammate of the player. For example, as shown in FIG. 3, “Following a teammate for evacuation” is a following control for the teammate virtual character. The teammate may click on “Yes”, and the determined team evacuation rule for the teammate virtual character is the second evacuation rule, that is, being willing to follow the first virtual character as the teammate for evacuation together. If the teammate clicks on “No”, the determined team evacuation rule for the teammate virtual character is unwilling to follow the first virtual character as the teammate for evacuation together.

After the teammate performs the selection, the second terminal device sends the selected information to the first terminal device, so that the team evacuation rule for each teammate virtual character may be determined. In this way, by selecting the team evacuation rule for the virtual character in advance, the player may obtain the benefit relationship brought by forming a team in the game, thus improving the willingness of the player to form a team.

(2) Based on the first evacuation rule and the second evacuation rule, the target virtual character that is able to be evacuated along with the first virtual character is determined from the second virtual character, where the first evacuation rule at least includes being willing to carry a teammate for evacuation together, and the second evacuation rule at least includes being willing to follow a teammate for evacuation together.

In some embodiments, as long as the first virtual character is preset with an evacuation rule of being willing to carry the second virtual character as the teammate for evacuation together, and the second virtual character is preset with an evacuation rule of being willing to follow the first virtual character as the teammate for evacuation together, the second virtual character is directly determined as the target virtual character that is able to be evacuated along with the first virtual character.

In another possible implementation, on the basis of the foregoing, the position where the second virtual character is located is further determined. In some embodiments, according to the position of the target evacuation point and the position where the second virtual character is located, the target virtual character that is able to be evacuated along with the first virtual character may be determined from the second virtual character.

In some embodiments, the target virtual character that is able to be evacuated along with the first virtual character in the second virtual character is determined based on the first evacuation rule, the second evacuation rule, and the position of the target evacuation point in the game battle scene.

In some embodiments, a thumbnail of a game map is displayed in the graphical user interface; a target scene area is determined, where the target scene area is a scene area taking the target evacuation point as the circle center and taking a first value as the radius; an area identifier of the target scene area is displayed on the thumbnail of the game map; and, the target virtual character in other scene areas except for the target evacuation point in the target scene area is determined.

In some embodiments, after the player controls the first virtual character to move to the target evacuation point in the game battle scene, the game system may automatically determine the target scene area by taking the target evacuation point as the circle center and taking the first value as the radius, and determine the second virtual character located in the target scene area but not located at the target evacuation point as the target virtual character, where the first value is usually preset according to the actual game requirement, for example, 200 meters, 300 meters, etc.

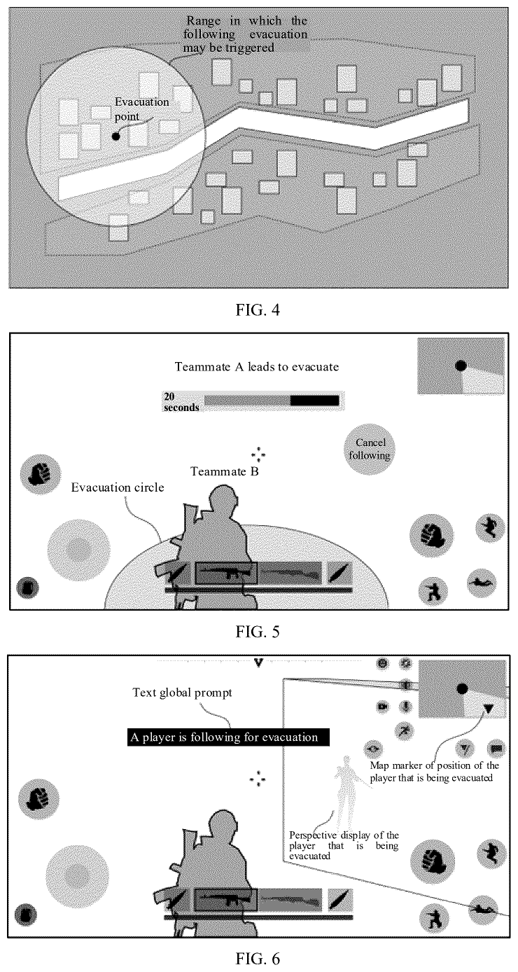

The thumbnail of the game map may also be displayed on the graphical user interface, and may usually be displayed at the upper right corner of the graphical user interface. In normal cases, the thumbnail of the game map displays the position identifier of the player in the game battle scene. After the target scene area is determined, the thumbnail of the game map may display the area identifier of the target scene area. For example, as shown in the thumbnail of the game map shown in FIG. 4, the evacuation point corresponds to the target evacuation point, and the range in which the following evacuation event may be triggered corresponds to the target scene area. In this manner, the target scene area is set in the surrounding area of the specified scene position, and the second virtual character in the target scene area is determined as the target virtual character, thus further enriching the playing method of the team-forming game.

Furthermore, in response to the target virtual character moving to the target evacuation point, it is cancelled that the target virtual character and the first virtual character are evacuated from the game battle together, and the target virtual character is controlled to be evacuated from the game battle separately.

When the target virtual character is evacuated from the game battle together with the first virtual character, the teammate may usually control the target virtual character to move. When the teammate controls the target virtual character to move from a certain position in the target scene area to the target evacuation point, the teammate may cancel that the target virtual character follows the first virtual character to be evacuated from the game battle together, and may change it to a normal evacuation of an individual from the game battle. At this time, the target virtual character may not follow other virtual characters.

Furthermore, in response to the target virtual character moving to a scene position outside the target scene area, the target virtual character is cancelled to follow the first virtual character for evacuation from the game battle together.

Similarly, when the teammate controls the target virtual character to move from a certain position in the target scene area to a scene area outside the target scene area, it may be cancelled that the target virtual character follows the first virtual character for evacuation from the game battle together.

In the following description, before the step of controlling to evacuate the first virtual character and the target virtual character from the game battle together, the method further includes:
obtaining character position information of the first virtual character and the target virtual character in the game battle scene, and broadcasting the character position information, to enable all virtual characters participating in the game battle to learn positions of the first virtual character and the target virtual character in the game battle scene through the character position information.

In some embodiments, a thumbnail of the game map is displayed on the graphical user interface provided by a third terminal device. By using the third terminal device, in response to the target virtual character and the target virtual character being evacuated from the game battle together, that is, receiving the character position information, a character position identifier of the first virtual character in the game battle scene and a character position identifier of the target virtual character in the game battle are displayed in the game map.

Generally, the position identifier of the first virtual character and the position identifier of the target virtual character are displayed at the upper right corner of the graphical user interface. For example, as shown in FIG. 6, the triangle identifier indicated by “Map marker of position of the player that is being evacuated” in FIG. 6, is the position identifier of the first virtual character in the game battle scene.

In some embodiments, the game map is not displayed; and, after the character position information is received, the character position identifier of the character position information is directly displayed on the graphical user interface to indicate the relative positions of the first virtual character and the target virtual character relative to a third virtual character.

Furthermore, the graphical user interface provided by the third terminal device may be controlled to display third prompt information and a perspective screen of the first virtual character or the target virtual character, where the third prompt information is configured to prompt that there is currently an enemy virtual character that is following the teammate to be evacuated from the game battle. The perspective screen is obtained by shooting on the game battle scene using a virtual camera corresponding to the first virtual character, or is obtained by shooting on the game battle scene using a virtual camera corresponding to the target virtual character.

For example, as shown in FIG. 6, “A player is following for evacuation” in FIG. 6 corresponds to the third prompt information, where the virtual character indicated by “Perspective display of the player that is being evacuated” is the above perspective screen of the first virtual character. In this manner, by exposing the position of the character during evacuation to the local player, the strategic nature of the game is improved.

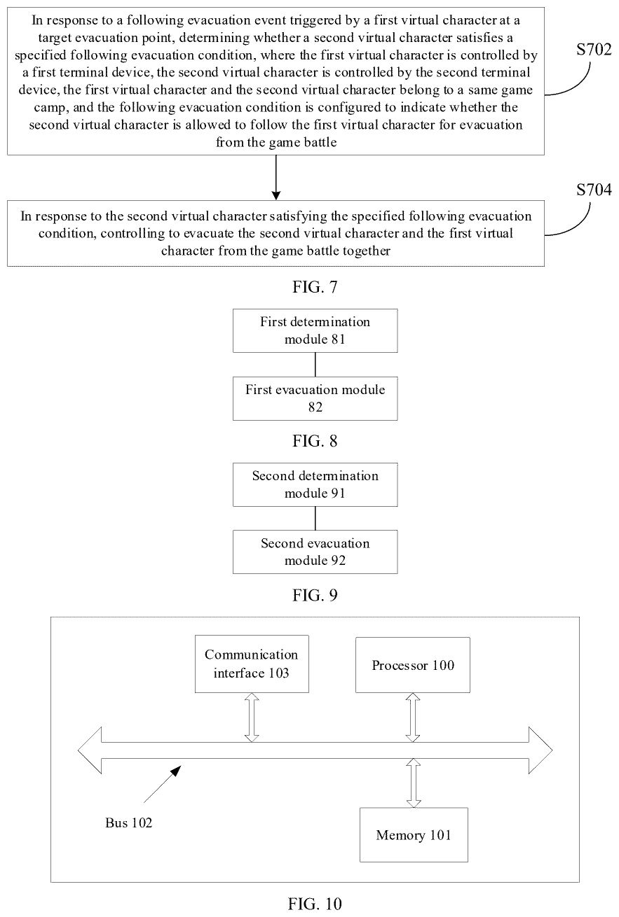

According to some embodiments of the present disclosure, there is provided another method for controlling a virtual character, where a graphical user interface is provided by a second terminal device, a content displayed on the graphical user interface includes at least a part of a game battle scene, the game battle scene includes at least one evacuation point, the at least one evacuation point is configured to provide a service of evacuation from a game battle for a virtual character that satisfies an evacuation condition. As shown in FIG. 7, the method includes the following steps.

In step S702, in response to a following evacuation event triggered by a first virtual character at a target evacuation point, it is determined whether a second virtual character satisfies a specified following evacuation condition, where the first virtual character is controlled by a first terminal device, the second virtual character is controlled by the second terminal device, the first virtual character and the second virtual character belong to a same game camp, and the following evacuation condition is configured to indicate whether the second virtual character is allowed to follow the first virtual character for evacuation from the game battle.

In some embodiments, the second terminal device is used as an execution body. When a teammate virtual character (i.e., the first virtual character) triggers the following evacuation event at the target evacuation point, it may be determined, according to the evacuation rule preset by the player, whether the second virtual character is willing to follow the first virtual character as the teammate for evacuation from the game battle together.

In some embodiments, in response to the first virtual character moving to the target evacuation point in the game battle scene, and the first virtual character satisfying the evacuation condition corresponding to the target evacuation point, the following evacuation event for the target evacuation point is triggered.

In step S704, in response to the second virtual character satisfying the specified following evacuation condition, the second virtual character and the first virtual character are controlled to be evacuated from the game battle together.

In some embodiments, in response to the following evacuation event triggered by the first virtual character at the target evacuation point, a first evacuation rule pre-specified for the first virtual character and a second evacuation rule pre-specified for the second virtual character are determined; and, based on the first evacuation rule and the second evacuation rule, it is determined whether the second virtual character satisfies the specified following evacuation condition, where the first evacuation rule at least includes whether being willing to carry a teammate for evacuation together, and the second evacuation rule at least includes whether being willing to be follow a teammate for evacuation together.

In the foregoing embodiment, in response to the following evacuation event triggered by the first virtual character at the target evacuation point, it is determined whether the second virtual character satisfies the specified following evacuation condition, where the first virtual character is controlled by the first terminal device, the second virtual character is controlled by the second terminal device, the first virtual character and the second virtual character belong to the same game camp, and the following evacuation condition is configured to indicate whether the second virtual character is allowed to follow the first virtual character for evacuation from the game battle; and, in response to the second virtual character satisfying the specified following evacuation condition, the second virtual character and the first virtual character are controlled to be evacuated from the game battle together. In this way, by using the pre-specified team evacuation rule, the evacuation rule for the first virtual character and the evacuation rule for the virtual character that belongs to the same camp as the first virtual character may be determined, so as to determine the second virtual character that is able to be evacuated along with the first virtual character, and control to evacuate the first virtual character and the second virtual character from the game battle together, thus improving the team-forming willingness of the player in the game, and further improving the game experience of the player.

For the step of in response to the following evacuation event triggered by the first virtual character at the target evacuation point, determining whether the second virtual character satisfies the specified following evacuation condition, a possible implementation is as following.

In response to the following evacuation event triggered by the first virtual character at the target evacuation point, a first evacuation rule pre-specified for the first virtual character, a second evacuation rule pre-specified for the second virtual character, and a position of the target evacuation point in the game battle scene are determined; and, based on the first evacuation rule, the second evacuation rule, and the position of the target evacuation point in the game battle scene, it is determined whether the second virtual character satisfies the specified following evacuation condition, where the first evacuation rule at least includes whether being willing to carry a teammate for evacuation together, and the second evacuation rule at least includes whether being willing to follow a teammate for evacuation together.

Furthermore, the method further includes: controlling the graphical user interface to display second prompt information, a second target time, a countdown of the second target time, and a control for cancelling following, where the second prompt information is configured to prompt that the second virtual character is following the first virtual character for evacuation from the game battle together, and the second target time is configured to prompt a waiting duration required for the second virtual character to follow the first virtual character for evacuation from the game battle together.

In addition, for the step of in response to the second virtual character satisfying the specified following evacuation condition, controlling to evacuate the second virtual character and the first virtual character from the game battle together, another possible implementation is: in response to the second virtual character satisfying the specified following evacuation condition, controlling to generate a target evacuation area in the game battle scene; and, in response to the second virtual character being in the target evacuation area, controlling to evacuate the second virtual character and the first virtual character from the game battle together.

When the second virtual character follows the first virtual character for evacuation from the game battle together, for example, as shown in FIG. 5, “Teammate A leads to evacuate” in FIG. 5 corresponds to the second prompt information, 20 seconds in FIG. 5 corresponds to the second target time, the gray and black bar-shaped frame in FIG. 5 corresponds to the countdown of the second target time, and “Cancel following” in FIG. 5 corresponds to the control for cancelling following. In some embodiments, the teammate A is the first virtual character, and the teammate B is the second virtual character.

The target evacuation area may be a circular area with a specified distance as a radius and the position where the second virtual character is located as a circle center. The target evacuation area may also be a circular area with a specified position as a circle center and a specified distance as a radius. During actual implementation, a following special effect may be displayed in the target evacuation area, and the following special effect may be displaying the target evacuation area in a highlighted form, or may be displaying the target evacuation area in a specified color, or may be displaying a circle of a color on the target evacuation area, or may be further flashing the circle. For example, “Evacuation circle” shown in FIG. 5 is the following special effect. By displaying the following special effect, the following state of the player may be further prompted, thus making the game more diverse.

During actual implementation, only when the player controls the second virtual character to wait for the second target time in the target evacuation area, the first virtual character and the second virtual character may be evacuated from the game battle.

In addition, in response to a trigger operation on the control for cancelling following, the second virtual character is cancelled to leave the game battle by following the first virtual character together.

For the step of in response to the second virtual character being in the target evacuation area, controlling to evacuate the second virtual character and the first virtual character from the game battle together, a possible implementation manner is: in response to the second virtual character entering the target evacuation area within a specified time, controlling to evacuate the second virtual character and the first virtual character from the game battle together.

The specified time is the waiting duration required for evacuation of the first virtual character and the second virtual character from the game battle together. That is, the second virtual character has to wait for the waiting duration in the target evacuation area to complete the game behavior of evacuation from the game battle together.

For the step of in response to the second virtual character being in the target evacuation area, controlling to evacuate the second virtual character and the first virtual character from the game battle together, another possible implementation manner is: in response to the second virtual character being in the target evacuation area and completing a specified game behavior within the target evacuation area, controlling to evacuate the second virtual character and the first virtual character from the game battle together.

The specified game behavior includes not performing an attack and not being attacked. For example, after the target evacuation area is generated, and the player controls the second virtual character to be located in the target evacuation area, the player controls the second virtual character to follow the first virtual character for evacuation from the game battle together. However, when the second virtual character is located within the target evacuation area, the player usually does not control the second virtual character to leave the target evacuation area, and controls the second virtual character neither not to attack other virtual characters nor to be attacked by other virtual characters; and, only the game behavior is completed, the player controls to evacuate the second virtual character and the first virtual character from the game battle together.

In other words, if the player controls the second virtual character to leave the target evacuation area, the player may cancel that the second virtual character follows the first virtual character for evacuation from the game battle together. Similarly, if the second virtual character is attacked or performs attack on other virtual characters, the player may also cancel that the second virtual character follows the first virtual character for evacuation from the game battle together. In this case, the second prompt information, the second target time, the countdown of the second target time, and the control for cancelling following displayed on the graphical user interface may be cancelled.

Before the step of controlling to evacuate the second virtual character and the first virtual character from the game battle together, the method further includes: obtaining character position information of the first virtual character and the second virtual character in the game battle scene, and broadcasting the character position information, to enable all virtual characters participating in the game battle to learn positions of the first virtual character and the second virtual character in the game battle scene through the character position information.

Corresponding to the foregoing method embodiments, according to some embodiments of the present disclosure, there is provided an apparatus for controlling a virtual character, where a graphical user interface is provided by a first terminal device, a content displayed on the graphical user interface includes at least a part of a game battle scene, the game battle scene includes at least one evacuation point, the at least one evacuation point is configured to provide a service of evacuation from a game battle for a virtual character that satisfies an evacuation condition. As shown in FIG. 8, the apparatus includes a first determination module 81 and a first evacuation module 82.

The first determination module 81 is configured to, in response to a following evacuation event triggered by a first virtual character at a target evacuation point, determine, according to a pre-specified team evacuation rule, a target virtual character that is able to be evacuated along with the first virtual character, where the first virtual character is controlled by the first terminal device, and the first virtual character and the target virtual character belong to a same game camp.

The first evacuation module 82 is configured to control to evacuate the first virtual character and the target virtual character from the game battle together.

The present disclosure provides an apparatus for controlling a virtual character. In response to a following evacuation event triggered by a first virtual character at a target evacuation point, a target virtual character that is able to be evacuated along with the first virtual character is determined according to a pre-specified team evacuation rule; the first virtual character and the target virtual character belong to the same game camp; and, the first virtual character and the target virtual character are controlled to be evacuated from the game battle together. In this way, by using the pre-specified team evacuation rule, the evacuation rule for the first virtual character and the evacuation rule for the virtual character that belongs to the same camp as the first virtual character may be determined, so as to determine the target virtual character that is able to be evacuated along with the first virtual character, and control to evacuate the first virtual character and the target virtual character from the game battle together, thus improving the team-forming willingness of the player in the game, and further improving the game experience of the player.

In some embodiments, in response to a quantity of the target virtual character being 0, the first virtual character is controlled to be evacuated from the game battle within a first preset time.

In some embodiments, in response to the quantity of the target virtual character being not 0, the first virtual character and the target virtual character are controlled to be evacuated from the game battle within a second preset time, where the second preset time is greater than the first preset time, and the second preset time is positively correlated with the quantity of the target virtual character.

In some embodiments, the second preset time is further positively correlated with a quantity of a virtual item obtained by the first virtual character and the target virtual character in the game battle.

In some embodiments, it is controlled to display first prompt information on the graphical user interface, where the first prompt information at least includes first target time information, and the first target time information is at least configured to prompt a waiting duration required for evacuation of the first virtual character and the target virtual character from the game battle together; and, in response to reaching the waiting duration, the first virtual character and the target virtual character are controlled to be evacuated from the game battle together.

In some embodiments, in response to the following evacuation event triggered by the first virtual character at the target evacuation point, a first evacuation rule pre-specified for the first virtual character and a second evacuation rule pre-specified for the second virtual character are determined, where the second virtual character is a virtual character controlled by a second terminal device; and, based on the first evacuation rule and the second evacuation rule, a target virtual character that is able to be evacuated along with the first virtual character is determined from the second virtual character, where the first evacuation rule at least includes being willing to carry a teammate for evacuation together, and the second evacuation rule at least includes being willing to follow a teammate for evacuation together.

In some embodiments, the apparatus for controlling the virtual character further includes a rule determination module, configured to: in response to the game battle starting, a preset team evacuation rule is displayed on the graphical user interface, where the team evacuation rule at least includes whether being willing to carry the teammate for evacuation together and whether being willing to follow the teammate for evacuation together; and in response to a selection operation for a target evacuation rule in the team evacuation rule, it is determined that the target evacuation rule is the first evacuation rule corresponding to the first virtual character.

In some embodiments, the rule determination module is further configured to determine, based on the first evacuation rule, the second evacuation rule, and a position of the target evacuation point in the game battle scene, a target virtual character that is able to be evacuated along with the first virtual character, from the second virtual character.

In some embodiments, the apparatus for controlling the virtual character further includes a first trigger module, configured to, in response to the first virtual character moving to the target evacuation point in the game battle scene, and the first virtual character satisfies an evacuation condition corresponding to the target evacuation point, trigger the following evacuation event for the target evacuation point.

In some embodiments, the apparatus for controlling the virtual character further includes a first sending module, configured to: obtain character position information of the first virtual character and the target virtual character in the game battle scene, and broadcast the character position information, to enable all virtual characters participating in the game battle to learn positions of the first virtual character and the target virtual character in the game battle scene through the character position information.

In a second aspect, according to some embodiments of the present disclosure, there is provided an apparatus for controlling a virtual character, where a graphical user interface is provided by a second terminal device, a content displayed on the graphical user interface includes at least a part of a game battle scene, the game battle scene includes at least one evacuation point, the at least one evacuation point is configured to provide a service of evacuation from a game battle for a virtual character that satisfies an evacuation condition. As shown in FIG. 9, the apparatus includes a second determination module 91 and a second evacuation module 92.

The second determination module 91 is configured to, in response to a following evacuation event triggered by a first virtual character at a target evacuation point, determine whether a second virtual character satisfies a specified following evacuation condition, where the first virtual character is controlled by a first terminal device, the second virtual character is controlled by the second terminal device, the first virtual character and the second virtual character belong to a same game camp, and the following evacuation condition is configured to indicate whether the second virtual character is allowed to follow the first virtual character for evacuation from the game battle.

The second evacuation module 92 is configured to, in response to the second virtual character satisfying the specified following evacuation condition, control to evacuate the second virtual character and the first virtual character from the game battle together.

According to some embodiments of the present disclosure, there is provided an apparatus for controlling a virtual character. In response to the following evacuation event triggered by the first virtual character at the target evacuation point, it is determined whether the second virtual character satisfies the specified following evacuation condition, where the first virtual character is controlled by the first terminal device, the second virtual character is controlled by the second terminal device, the first virtual character and the second virtual character belong to the same game camp, and the following evacuation condition is configured to indicate whether the second virtual character is allowed to follow the first virtual character for evacuation from the game battle; and, in response to the second virtual character satisfying the specified following evacuation condition, the second virtual character and the first virtual character are controlled to be evacuated from the game battle together. In this way, by using the pre-specified team evacuation rule, the evacuation rule for the first virtual character and the evacuation rule for the virtual character that belongs to the same camp as the first virtual character may be determined, so as to determine the second virtual character that is able to be evacuated along with the first virtual character, and control to evacuate the first virtual character and the second virtual character from the game battle together, thus improving the team-forming willingness of the player in the game, and further improving the game experience of the player.

In some embodiments, the apparatus for controlling the virtual character further includes a second trigger module, configured to, in response to the first virtual character moving to the target evacuation point in the game battle scene, and the first virtual character satisfies an evacuation condition corresponding to the target evacuation point, trigger the following evacuation event for the target evacuation point.

In some embodiments, the second determination module is further configured to: in response to the following evacuation event triggered by the first virtual character at the target evacuation point, determine a first evacuation rule pre-specified for the first virtual character and a second evacuation rule pre-specified for the second virtual character; and determine, based on the first evacuation rule and the second evacuation rule, whether the second virtual character satisfies the specified following evacuation condition, where the first evacuation rule at least includes whether being willing to carry a teammate for evacuation together, and the second evacuation rule at least includes whether being willing to follow a teammate for evacuation together.

In some embodiments, the second determination module is further configured to: in response to the following evacuation event triggered by the first virtual character at the target evacuation point, determine a first evacuation rule pre-specified for the first virtual character, a second evacuation rule pre-specified for the second virtual character, and a position of the target evacuation point in the game battle scene; and, determine, based on the first evacuation rule, the second evacuation rule, and the position of the target evacuation point in the game battle scene, whether the second virtual character satisfies the specified following evacuation condition, where the first evacuation rule at least includes being willing to carry a teammate for evacuation together, and the second evacuation rule at least includes whether being willing to follow a teammate for evacuation together.

In some embodiments, the second evacuation module is further configured to: in response to the second virtual character satisfying the specified following evacuation condition, control to generate a target evacuation area in the game battle scene; and in response to the second virtual character being in the target evacuation area, control to evacuate the second virtual character and the first virtual character from the game battle together.

In some embodiments, the second evacuation module is further configured to: in response to the second virtual character entering the target evacuation area within a specified time, control to evacuate the second virtual character and the first virtual character from the game battle together.

In some embodiments, the second evacuation module is further configured to: in response to the second virtual character being in the target evacuation area and completing a specified game behavior within the target evacuation area, control to evacuate the second virtual character and the first virtual character from the game battle together.

In some embodiments, the apparatus for controlling the virtual character further includes a second sending module, configured to: obtain character position information of the first virtual character and the second virtual character in the game battle scene, and broadcast the character position information, to enable all virtual characters participating in the game battle to learn positions of the first virtual character and the second virtual character in the game battle scene through the character position information.

The apparatus for controlling the virtual character provided by the embodiments of the present disclosure has identical technical features as the method for controlling the virtual character provided by the foregoing embodiment, and therefore can also solve the same technical problem and achieve the same technical effect.

According to this embodiment, there is further provided an electronic device including a processor and a memory, where the memory stores a machine-executable instruction that can be executed by the processor, and the processor executes the machine-executable instruction to implement the foregoing method for controlling the virtual character. The electronic device may be a server, or may be a terminal device.

Referring to FIG. 10, the electronic device includes a processor 100 and a memory 101. The memory 101 stores a machine-executable instruction that can be executed by the processor 100, and the processor 100 executes machine-executable instruction to implement the foregoing method for controlling the virtual character.

Furthermore, the electronic device shown in FIG. 10 further includes a bus 102 and a communication interface 103. The processor 100, the communication interface 103, and the memory 101 are connected by using the bus 102.

Among them, the memory 101 may include a high-speed random access memory (RAM), or may further include a non-volatile memory, for example, at least one magnetic disk memory. The communication connection between a system network element and at least one other network element may be implemented by using at least one communication interface 103 (which may be wired or wireless), where the Internet, a wide area network, a local network, a metropolitan area network, or the like, may be used. The bus 102 may be an ISA bus, a PCI bus, an EISA bus, or the like. The bus may be classified into an address bus, a data bus, a control bus, or the like. For ease of representation, only one bidirectional arrow is used to represent the bus in FIG. 10, but this does not mean that there is only one bus or one type of bus.

The processor 100 may be an integrated circuit chip, and has a signal processing capability. During implementation, steps of the foregoing method may be completed by using an integrated logic circuit of hardware in the processor 100 or an instruction in a form of software. The processor 100 may be a general-purpose processor, including a Central Processing Unit (CPU), a Network Processor (NP), or the like; or, the processor 100 may be a Digital Signal Processor (DSP), an Application Specific Integrated Circuit (ASIC), a Field-Programmable Gate Array (FPGA) or another programmable logic device, a discrete gate or transistor logic device, or a discrete hardware component. The processor may implement or execute the methods, steps, and logical block diagrams disclosed in the embodiments of the present disclosure. The general-purpose processor may be a microprocessor; or, the processor may be any conventional processor, or the like. The steps of the methods disclosed with reference to the embodiments of the present disclosure may be directly performed by a hardware decoding processor, or may be performed and completed by using a combination of hardware and software modules in a decoding processor. The software module may be located in a mature storage medium in the art, such as a random access memory, a flash memory, a read-only memory, a programmable read-only memory, an electrically erasable programmable memory, or a register. The storage medium is located in the memory 101, and the processor 100 reads information in the memory 101 and completes the steps of the method for controlling the virtual character of the foregoing embodiment in combination with hardware of the processor 100. The method for controlling the virtual character using a first terminal device as an execution body specifically includes following contents.

In response to a following evacuation event triggered by a first virtual character at a target evacuation point, a target virtual character that is able to be evacuated along with the first virtual character is determined according to a pre-specified team evacuation rule, where the first virtual character is controlled by the first terminal device, and the first virtual character and the target virtual character belong to the same game camp; and, the first virtual character and the target virtual character are controlled to be evacuated from the game battle together. In this way, by using the pre-specified team evacuation rule, the evacuation rule for the first virtual character and the evacuation rule for the virtual character that belongs to the same camp as the first virtual character may be determined, so as to determine the target virtual character that is able to be evacuated along with the first virtual character, and control to evacuate the first virtual character and the target virtual character from the game battle together, thus improving the team-forming willingness of the player in the game, and further improving the game experience of the player.

In some embodiments, the step of controlling to evacuate the first virtual character and the target virtual character from the game battle together includes: in response to a quantity of the target virtual character being 0, controlling to evacuate the first virtual character from the game battle within a first preset time.

In some embodiments, the step of controlling to evacuate the first virtual character and the target virtual character from the game battle together includes: in response to the quantity of the target virtual character being not 0, controlling to evacuate the first virtual character and the target virtual character from the game battle within a second preset time, where the second preset time is greater than the first preset time, and the second preset time is positively correlated with the quantity of the target virtual character.

In some embodiments, the second preset time is further positively correlated with a quantity of a virtual item obtained by the first virtual character and the target virtual character in the game battle.

In some embodiments, the step of controlling to evacuate the first virtual character and the target virtual character from the game battle together includes: controlling to display first prompt information on the graphical user interface, where the first prompt information at least includes first target time information, and the first target time information is at least configured to prompt a waiting duration required for evacuation of the first virtual character and the target virtual character from the game battle together; and, in response to reaching the waiting duration, controlling to evacuate the first virtual character and the target virtual character from the game battle together.

In some embodiments, the step of in response to the following evacuation event triggered by the first virtual character at the target evacuation point, determining, according to the pre-specified team evacuation rule, the target virtual character that is able to be evacuated along with the first virtual character includes: in response to the following evacuation event triggered by the first virtual character at the target evacuation point, determining a first evacuation rule pre-specified for the first virtual character and a second evacuation rule pre-specified for a second virtual character, where the second virtual character is a virtual character controlled by a second terminal device; and determining, based on the first evacuation rule and the second evacuation rule, the target virtual character that is able to be evacuated along with the first virtual character, from the second virtual character; where the first evacuation rule at least includes being willing to carry a teammate for evacuation together, and the second evacuation rule at least includes being willing to follow a teammate for evacuation together.

In some embodiments, the method for controlling the virtual character further includes: in response to the game battle starting, displaying a preset team evacuation rule on the graphical user interface, where the team evacuation rule at least includes whether being willing to carry the teammate for evacuation together and whether being willing to follow the teammate for evacuation together; and, in response to a selection operation for a target evacuation rule in the team evacuation rule, determining that the target evacuation rule is the first evacuation rule corresponding to the first virtual character.

In some embodiments, the step of determining, based on the first evacuation rule and the second evacuation rule, the target virtual character that is able to be evacuated along with the first virtual character, from the second virtual character, includes: determining, based on the first evacuation rule, the second evacuation rule, and a position of the target evacuation point in the game battle scene, the target virtual character that is able to be evacuated along with the first virtual character, from the second virtual character.

In some embodiments, the method for controlling the virtual character further includes: in response to the first virtual character moving to the target evacuation point in the game battle scene, and the first virtual character satisfying an evacuation condition corresponding to the target evacuation point, triggering the following evacuation event for the target evacuation point.

In some embodiments, before the step of controlling to evacuate the first virtual character and the target virtual character from the game battle together, the method further includes: obtaining character position information of the first virtual character and the target virtual character in the game battle scene, and broadcasting the character position information, to enable all virtual characters participating in the game battle to learn positions of the first virtual character and the target virtual character in the game battle scene through the character position information.

The method for controlling the virtual character using a second terminal device as an execution body specifically includes following contents.

In response to the following evacuation event triggered by the first virtual character at the target evacuation point, it is determined whether the second virtual character satisfies the specified following evacuation condition, where the first virtual character is controlled by the first terminal device, the second virtual character is controlled by the second terminal device, the first virtual character and the second virtual character belong to the same game camp, and the following evacuation condition is configured to indicate whether the second virtual character is allowed to follow the first virtual character for evacuation from the game battle; and, in response to the second virtual character satisfying the specified following evacuation condition, the second virtual character and the first virtual character are controlled to be evacuated from the game battle together. In this way, by using the pre-specified team evacuation rule, the evacuation rule for the first virtual character and the evacuation rule for the virtual character that belongs to the same camp as the first virtual character may be determined, so as to determine the second virtual character that is able to be evacuated along with the first virtual character, and control to evacuate the first virtual character and the second virtual character from the game battle together, thus improving the team-forming willingness of the player in the game, and further improving the game experience of the player.

In some embodiments, the method for controlling a virtual character further includes: in response to the first virtual character moving to the target evacuation point in the game battle scene, and the first virtual character satisfying an evacuation condition corresponding to the target evacuation point, triggering the following evacuation event for the target evacuation point.

In some embodiments, the step of in response to the following evacuation event triggered by the first virtual character at the target evacuation point, determining whether the second virtual character satisfies the specified following evacuation condition includes: in response to the following evacuation event triggered by the first virtual character at the target evacuation point, determining a first evacuation rule pre-specified for the first virtual character and a second evacuation rule pre-specified for the second virtual character; and, determining, based on the first evacuation rule and the second evacuation rule, whether the second virtual character satisfies the specified following evacuation condition, where the first evacuation rule at least includes whether being willing to carry a teammate for evacuation together, and the second evacuation rule at least includes whether being willing to follow a teammate for evacuation together.

In some embodiments, the step of in response to the following evacuation event triggered by the first virtual character at the target evacuation point, determining whether the second virtual character satisfies the specified following evacuation condition includes: in response to the following evacuation event triggered by the first virtual character at the target evacuation point, determining a first evacuation rule pre-specified for the first virtual character, a second evacuation rule pre-specified for the second virtual character, and a position of the target evacuation point in the game battle scene; and, determining, based on the first evacuation rule, the second evacuation rule, and the position of the target evacuation point in the game battle scene, whether the second virtual character satisfies the specified following evacuation condition, where the first evacuation rule at least includes whether being willing to carry a teammate for evacuation together, and the second evacuation rule at least includes whether being willing to follow a teammate for evacuation together.

In some embodiments, the step of in response to the second virtual character satisfying the specified following evacuation condition, controlling to evacuate the second virtual character and the first virtual character from the game battle together includes: in response to the second virtual character satisfying the specified following evacuation condition, controlling to generate a target evacuation area in the game battle scene; and in response to the second virtual character being in the target evacuation area, controlling to evacuate the second virtual character and the first virtual character from the game battle together.

In some embodiments, the step of in response to the second virtual character being in the target evacuation area, controlling to evacuate the second virtual character and the first virtual character from the game battle together includes: in response to the second virtual character entering the target evacuation area within a specified time, controlling to evacuate the second virtual character and the first virtual character from the game battle together.

In some embodiments, the step of in response to the second virtual character being in the target evacuation area, controlling to evacuate the second virtual character and the first virtual character from the game battle together includes: in response to the second virtual character being in the target evacuation area and completing a specified game behavior within the target evacuation area, controlling to evacuate the second virtual character and the first virtual character from the game battle together.

In some embodiments, before the step of controlling to evacuate the second virtual character and the first virtual character from the game battle together, the method further includes: obtaining character position information of the first virtual character and the second virtual character in the game battle scene, and broadcasting the character position information, to enable all virtual characters participating in the game battle to learn positions of the first virtual character and the second virtual character in the game battle scene through the character position information.

According to this embodiment, there is further provides a machine-readable storage medium, where the machine-readable storage medium stores a machine-executable instruction, and when the machine-executable instruction is invoked and executed by the processor, the machine-executable instruction causes the processor to implement the foregoing method for controlling the virtual character.

The method for controlling the virtual character using a first terminal device as an execution body specifically includes following contents.

In response to a following evacuation event triggered by a first virtual character at a target evacuation point, a target virtual character that is able to be evacuated along with the first virtual character is determined according to a pre-specified team evacuation rule, where the first virtual character is controlled by the first terminal device, and the first virtual character and the target virtual character belong to the same game camp; and, the first virtual character and the target virtual character are controlled to be evacuated from the game battle together. In this way, by using the pre-specified team evacuation rule, the evacuation rule for the first virtual character and the evacuation rule for the virtual character that belongs to the same camp as the first virtual character may be determined, so as to determine the target virtual character that is able to be evacuated along with the first virtual character, and control to evacuate the first virtual character and the target virtual character from the game battle together, thus improving the team-forming willingness of the player in the game, and further improving the game experience of the player.

In some embodiments, the step of controlling to evacuate the first virtual character and the target virtual character from the game battle together includes: in response to a quantity of the target virtual character being 0, controlling to evacuate the first virtual character from the game battle within a first preset time.

In some embodiments, the step of controlling to evacuate the first virtual character and the target virtual character from the game battle together includes: in response to the quantity of the target virtual character being not 0, controlling to evacuate the first virtual character and the target virtual character from the game battle within a second preset time, where the second preset time is greater than the first preset time, and the second preset time is positively correlated with the quantity of the target virtual character.

In some embodiments, the second preset time is further positively correlated with a quantity of a virtual item obtained by the first virtual character and the target virtual character in the game battle.

In some embodiments, the step of controlling to evacuate the first virtual character and the target virtual character from the game battle together includes: controlling to display first prompt information on the graphical user interface, where the first prompt information at least includes first target time information, and the first target time information is at least configured to prompt a waiting duration required for evacuation of the first virtual character and the target virtual character from the game battle together; and, in response to reaching the waiting duration, controlling to evacuate the first virtual character and the target virtual character from the game battle together.

In some embodiments, the step of in response to the following evacuation event triggered by the first virtual character at the target evacuation point, determining, according to the pre-specified team evacuation rule, the target virtual character that is able to be evacuated along with the first virtual character includes: in response to the following evacuation event triggered by the first virtual character at the target evacuation point, determining a first evacuation rule pre-specified for the first virtual character and a second evacuation rule pre-specified for a second virtual character, where the second virtual character is a virtual character controlled by a second terminal device; and determining, based on the first evacuation rule and the second evacuation rule, the target virtual character that is able to be evacuated along with the first virtual character, from the second virtual character; where the first evacuation rule at least includes being willing to carry a teammate for evacuation together, and the second evacuation rule at least includes being willing to follow a teammate for evacuation together.

In some embodiments, the method for controlling the virtual character further includes: in response to the game battle starting, displaying a preset team evacuation rule on the graphical user interface, where the team evacuation rule at least includes whether being willing to carry the teammate for evacuation together and whether being willing to follow the teammate for evacuation together; and, in response to a selection operation for a target evacuation rule in the team evacuation rule, determining that the target evacuation rule is the first evacuation rule corresponding to the first virtual character.

In some embodiments, the step of determining, based on the first evacuation rule and the second evacuation rule, the target virtual character that is able to be evacuated along with the first virtual character, from the second virtual character, includes: determining, based on the first evacuation rule, the second evacuation rule, and a position of the target evacuation point in the game battle scene, the target virtual character that is able to be evacuated along with the first virtual character, from the second virtual character.

In some embodiments, the method for controlling the virtual character further includes: in response to the first virtual character moving to the target evacuation point in the game battle scene, and the first virtual character satisfying an evacuation condition corresponding to the target evacuation point, triggering the following evacuation event for the target evacuation point.

In some embodiments, before the step of controlling to evacuate the first virtual character and the target virtual character from the game battle together, the method further includes: obtaining character position information of the first virtual character and the target virtual character in the game battle scene, and broadcasting the character position information, to enable all virtual characters participating in the game battle to learn positions of the first virtual character and the target virtual character in the game battle scene through the character position information.

The method for controlling the virtual character using a second terminal device as an execution body specifically includes following contents.

In response to the following evacuation event triggered by the first virtual character at the target evacuation point, it is determined whether the second virtual character satisfies the specified following evacuation condition, where the first virtual character is controlled by the first terminal device, the second virtual character is controlled by the second terminal device, the first virtual character and the second virtual character belong to the same game camp, and the following evacuation condition is configured to indicate whether the second virtual character is allowed to follow the first virtual character for evacuation from the game battle; and, in response to the second virtual character satisfying the specified following evacuation condition, the second virtual character and the first virtual character are controlled to be evacuated from the game battle together. In this way, by using the pre-specified team evacuation rule, the evacuation rule for the first virtual character and the evacuation rule for the virtual character that belongs to the same camp as the first virtual character may be determined, so as to determine the second virtual character that is able to be evacuated along with the first virtual character, and control to evacuate the first virtual character and the second virtual character from the game battle together, thus improving the team-forming willingness of the player in the game, and further improving the game experience of the player.

In some embodiments, the method for controlling a virtual character further includes: in response to the first virtual character moving to the target evacuation point in the game battle scene, and the first virtual character satisfying an evacuation condition corresponding to the target evacuation point, triggering the following evacuation event for the target evacuation point.

In some embodiments, the step of in response to the following evacuation event triggered by the first virtual character at the target evacuation point, determining whether the second virtual character satisfies the specified following evacuation condition includes: in response to the following evacuation event triggered by the first virtual character at the target evacuation point, determining a first evacuation rule pre-specified for the first virtual character and a second evacuation rule pre-specified for the second virtual character; and, determining, based on the first evacuation rule and the second evacuation rule, whether the second virtual character satisfies the specified following evacuation condition, where the first evacuation rule at least includes whether being willing to carry a teammate for evacuation together, and the second evacuation rule at least includes whether being willing to follow a teammate for evacuation together.

In some embodiments, the step of in response to the following evacuation event triggered by the first virtual character at the target evacuation point, determining whether the second virtual character satisfies the specified following evacuation condition includes: in response to the following evacuation event triggered by the first virtual character at the target evacuation point, determining a first evacuation rule pre-specified for the first virtual character, a second evacuation rule pre-specified for the second virtual character, and a position of the target evacuation point in the game battle scene; and, determining, based on the first evacuation rule, the second evacuation rule, and the position of the target evacuation point in the game battle scene, whether the second virtual character satisfies the specified following evacuation condition, where the first evacuation rule at least includes whether being willing to carry a teammate for evacuation together, and the second evacuation rule at least includes whether being willing to follow a teammate for evacuation together.

In some embodiments, the step of in response to the second virtual character satisfying the specified following evacuation condition, controlling to evacuate the second virtual character and the first virtual character from the game battle together includes: in response to the second virtual character satisfying the specified following evacuation condition, controlling to generate a target evacuation area in the game battle scene; and in response to the second virtual character being in the target evacuation area, controlling to evacuate the second virtual character and the first virtual character from the game battle together.

In some embodiments, the step of in response to the second virtual character being in the target evacuation area, controlling to evacuate the second virtual character and the first virtual character from the game battle together includes: in response to the second virtual character entering the target evacuation area within a specified time, controlling to evacuate the second virtual character and the first virtual character from the game battle together.

In some embodiments, the step of in response to the second virtual character being in the target evacuation area, controlling to evacuate the second virtual character and the first virtual character from the game battle together includes: in response to the second virtual character being in the target evacuation area and completing a specified game behavior within the target evacuation area, controlling to evacuate the second virtual character and the first virtual character from the game battle together.

In some embodiments, before the step of controlling to evacuate the second virtual character and the first virtual character from the game battle together, the method further includes: obtaining character position information of the first virtual character and the second virtual character in the game battle scene, and broadcasting the character position information, to enable all virtual characters participating in the game battle to learn positions of the first virtual character and the second virtual character in the game battle scene through the character position information.

The computer program product of the method for controlling a virtual character, the apparatus, the electronic device, and the system provided in the embodiments of the present disclosure includes a computer-readable storage medium storing program code, the instruction included in the program code may be configured to perform the method described in the foregoing method embodiments. For specific implementation, reference may be made to the method embodiments, and details are not described here again.

It may be clearly understood by those skilled in the art that, for the purpose of convenient and brief description, for the detailed working process of the system and apparatus described above, reference may be made to the corresponding process in the foregoing method embodiments, and details are not described here again.

In addition, in the description of the embodiments of the present disclosure, unless expressly specified and limited otherwise, the terms “installation”, “connection” and “connecting” should be understood in a broad sense, for example, it may be a fixed connection, a detachable connection, or an integral connection; or, it may be a mechanical connection or an electrical connection; or it may be a direct connection, or may be indirect connection by using an intermediate medium; or it may be a communication inside the two elements. For those skilled in the art, the specific meanings of the above terms in the present disclosure may be understood according to specific situations.

When the functions are implemented in the form of a software functional unit and sold or used as an independent product, the functions may be stored in a computer-readable storage medium. Based on such understanding, the technical solution of the present disclosure essentially, or a part of the technical solution that contributes to the related art, or a part of the technical solution may be embodied in the form of a software product, and the computer software product is stored in a storage medium, and includes several instructions for causing a computer device (which may be a personal computer, a server, or a network device) to perform all or part of the steps of the methods described in the embodiments of the present disclosure. The foregoing storage medium includes any medium that can store program code, such as a USB flash drive, a removable hard disk, a read-only memory (ROM), a random access memory (RAM), a magnetic disk, or an optical disk, etc.

In the description of the present disclosure, it should be noted that the orientation or position relationship indicated by the terms “center”, “upper”, “lower”, “left”, “right”, “vertical”, “horizontal”, “inner”, “outer” or the like is based on the orientation or position relationship shown in the accompanying drawings, rather than indicating or implying that the referred apparatus or element has to have a specific orientation and has to be constructed and operated in a specific orientation, and therefore cannot be understood as a limitation to the present disclosure. In addition, the terms “first”, “second” and “third” are used for descriptive purposes only and cannot be understood as indicating or implying relative importance.

Finally, it should be noted that, the above embodiments are only specific implementations of the present disclosure to illustrate the technical solution of the present disclosure, and are not limitations to the present disclosure, and the protection scope of the present disclosure is not limited to this. Although the present disclosure is described in detail with reference to the foregoing embodiments, those skilled in the art should understand that, any technical personnel familiar with this technical field may still modify or easily think of changes to the technical solution described in the aforementioned embodiments or may equivalently replace some of the technical features, within the technology scope disclosed in the present disclosure; and these modifications, changes, or replacements do not make the essence of the corresponding technical solution depart from the spirit and scope of the technical solution of the embodiments of the present disclosure, and should be covered within the protection scope of the present disclosure. Therefore, the protection scope of the present disclosure should be based on the protection scope of the claims.

1. A method for controlling a virtual character, performed by a first terminal device, and comprising:
in response to a following evacuation event triggered by a first virtual character at a target evacuation point, determining, according to a pre-specified team evacuation rule, a target virtual character that is evacuated along with the first virtual character, wherein a graphical user interface is provided by the first terminal device, a content displayed on the graphical user interface comprises a game battle scene, the game battle scene comprises at least one evacuation point, the at least one evacuation point is configured to provide a service of evacuation from a game battle for a virtual character that satisfies an evacuation condition, the first virtual character is controlled by the first terminal device, and the first virtual character and the target virtual character belong to a same game camp; and
controlling to evacuate the first virtual character and the target virtual character from the game battle together.

2. The method according to claim 1, wherein controlling to evacuate the first virtual character and the target virtual character from the game battle together comprises:
in response to a quantity of the target virtual character being 0, controlling to evacuate the first virtual character from the game battle within a first preset time.

3. The method according to claim 2, wherein controlling to evacuate the first virtual character and the target virtual character from the game battle together comprises:
in response to the quantity of the target virtual character being not 0, controlling to evacuate the first virtual character and the target virtual character from the game battle within a second preset time;
wherein the second preset time is greater than the first preset time, and the second preset time is positively correlated with the quantity of the target virtual character.

4. The method according to claim 3, wherein the second preset time is further positively correlated with a quantity of a virtual item obtained by the first virtual character and the target virtual character in the game battle.

5. The method according to claim 3, wherein controlling to evacuate the first virtual character and the target virtual character from the game battle together comprises:
controlling to display first prompt information on the graphical user interface, wherein the first prompt information at least comprises first target time information, and the first target time information is at least configured to prompt a waiting duration required for evacuation of the first virtual character and the target virtual character from the game battle together; and
in response to reaching the waiting duration, controlling to evacuate the first virtual character and the target virtual character from the game battle together.

6. The method according to claim 1, wherein in response to the following evacuation event triggered by the first virtual character at the target evacuation point, determining, according to the pre-specified team evacuation rule, the target virtual character that is evacuated along with the first virtual character comprises:
determining a first evacuation rule pre-specified for the first virtual character and a second evacuation rule pre-specified for a second virtual character, wherein the second virtual character is a virtual character controlled by a second terminal device; and
determining, based on the first evacuation rule and the second evacuation rule, the target virtual character that is evacuated along with the first virtual character, from the second virtual character;
wherein the first evacuation rule at least comprises being willing to carry a teammate for evacuation together, and the second evacuation rule at least comprises being willing to follow a teammate for evacuation together.

7. The method according to claim 6, further comprising:
in response to the game battle starting, displaying a preset team evacuation rule on the graphical user interface, wherein the team evacuation rule at least comprises whether being willing to carry the teammate for evacuation together and whether being willing to follow the teammate for evacuation together; and
in response to a selection operation for a target evacuation rule in the team evacuation rule, determining that the target evacuation rule is the first evacuation rule corresponding to the first virtual character.

8. The method according to claim 6, wherein determining, based on the first evacuation rule and the second evacuation rule, the target virtual character that is evacuated along with the first virtual character, from the second virtual character, comprises:
determining, based on the first evacuation rule, the second evacuation rule, and a position of the target evacuation point in the game battle scene, the target virtual character that is evacuated along with the first virtual character, from the second virtual character.

9. The method according to claim 1, further comprising at least one of:
in response to the first virtual character moving to the target evacuation point in the game battle scene, and the first virtual character satisfying an evacuation condition corresponding to the target evacuation point, triggering the following evacuation event for the target evacuation point; or
obtaining character position information of the first virtual character and the target virtual character in the game battle scene, and broadcasting the character position information, to enable all virtual characters participating in the game battle to learn positions of the first virtual character and the target virtual character in the game battle scene through the character position information.

10. (canceled)

11. A method for controlling a virtual character, performed by a second terminal device, and comprising:
in response to a following evacuation event triggered by a first virtual character at a target evacuation point, determining whether a second virtual character satisfies a specified following evacuation condition, wherein a graphical user interface is provided by the second terminal device, a content displayed on the graphical user interface comprises a game battle scene, the game battle scene comprises at least one evacuation point, the at least one evacuation point is configured to provide a service of evacuation from a game battle for a virtual character that satisfies an evacuation condition, the first virtual character is controlled by a first terminal device, the second virtual character is controlled by the second terminal device, the first virtual character and the second virtual character belong to a same game camp, and the following evacuation condition is configured to indicate whether the second virtual character is allowed to follow the first virtual character for evacuation from the game battle; and
in response to the second virtual character satisfying the specified following evacuation condition, controlling to evacuate the second virtual character and the first virtual character from the game battle together.

12. The method according to claim 11, further comprising:
in response to the first virtual character moving to the target evacuation point in the game battle scene, and the first virtual character satisfying an evacuation condition corresponding to the target evacuation point, triggering the following evacuation event for the target evacuation point.

13. The method according to claim 11, wherein in response to the following evacuation event triggered by the first virtual character at the target evacuation point, determining whether the second virtual character satisfies the specified following evacuation condition comprises:
character and a second evacuation rule pre-specified for the second virtual character; and
determining, based on the first evacuation rule and the second evacuation rule, whether the second virtual character satisfies the specified following evacuation condition;
wherein the first evacuation rule at least comprises whether being willing to carry a teammate for evacuation together, and the second evacuation rule at least comprises whether being willing to follow a teammate for evacuation together.

14. The method according to claim 11, wherein in response to the following evacuation event triggered by the first virtual character at the target evacuation point, determining whether the second virtual character satisfies the specified following evacuation condition comprises:
determining a first evacuation rule pre-specified for the first virtual character, a second evacuation rule pre-specified for the second virtual character, and a position of the target evacuation point in the game battle scene; and
determining, based on the first evacuation rule, the second evacuation rule, and the position of the target evacuation point in the game battle scene, whether the second virtual character satisfies the specified following evacuation condition;
wherein the first evacuation rule at least comprises whether being willing to carry a teammate for evacuation together, and the second evacuation rule at least comprises whether being willing to follow a teammate for evacuation together.

15. The method according to claim 13, wherein in response to the second virtual character satisfying the specified following evacuation condition, controlling to evacuate the second virtual character and the first virtual character from the game battle together comprises:
controlling to generate a target evacuation area in the game battle scene; and
in response to the second virtual character being in the target evacuation area, controlling to evacuate the second virtual character and the first virtual character from the game battle together.

16. The method according to claim 15, wherein in response to the second virtual character being in the target evacuation area, controlling to evacuate the second virtual character and the first virtual character from the game battle together comprises at least one of:
in response to the second virtual character entering the target evacuation area within a specified time, controlling to evacuate the second virtual character and the first virtual character from the game battle together; or
in response to the second virtual character being in the target evacuation area and completing a specified game behavior within the target evacuation area, controlling to evacuate the second virtual character and the first virtual character from the game battle together.

17. (canceled)

18. The method according to claim 15, further comprising:
obtaining character position information of the first virtual character and the second virtual character in the game battle scene, and broadcasting the character position information, to enable all virtual characters participating in the game battle to learn positions of the first virtual character and the second virtual character in the game battle scene through the character position information.

19. (canceled)

20. (canceled)

21. An electronic device, comprising a processor and a memory, wherein the memory stores a computer-executable instruction executable by the processor, and the processor executes the computer-executable instruction to implement a method for controlling a virtual character, comprising:
in response to a following evacuation event triggered by a first virtual character at a target evacuation point, determining, according to a pre-specified team evacuation rule, a target virtual character that is evacuated along with the first virtual character, wherein a graphical user interface is provided by the first terminal device, a content displayed on the graphical user interface comprises a game battle scene, the game battle scene comprises at least one evacuation point, the at least one evacuation point is configured to provide a service of evacuation from a game battle for a virtual character that satisfies an evacuation condition, the first virtual character is controlled by the first terminal device, and the first virtual character and the target virtual character belong to a same game camp; and
controlling to evacuate the first virtual character and the target virtual character from the game battle together.

22. A non-transitory computer-readable storage medium, wherein a computer-executable instruction is stored on the non-transitory_computer-readable storage medium, and when the computer-executable instruction is invoked and executed by a processor, the computer-executable instruction causes the processor to implement the method for controlling the virtual character according to claim 1.

23. An electronic device, comprising a processor and a memory, wherein the memory stores a computer-executable instruction executable by the processor, and the processor executes the computer-executable instruction to implement the method for controlling the virtual character according to claim 11.

24. A non-transitory computer-readable storage medium, wherein a computer-executable instruction is stored on the non-transitory computer-readable storage medium, and when the computer-executable instruction is invoked and executed by a processor, the computer-executable instruction causes the processor to implement the method for controlling the virtual character according to claim 11.
